(19) United States
(12) Patent Application Publication
(10) Pub. No.: US 2011/0118049 A1
(43) Pub. Date: May 19, 2011

(54) LASER ETCHING OF SURFACE FEATURES AND CYLINDRICAL ARTICLES PRODUCED THEREBY

(75) Inventors: GENE SIMPSON, Highland Village, TX (US); MEHMET M. ERHAN, Dallas, TX (US)

(73) Assignee: UNITED SPORTS TECHNOLOGIES, L.P., Fort Worth, TX (US)

(21) Appl. No.: 12/945,631

(22) Filed: Nov. 12, 2010

Related U.S. Application Data
(60) Provisional application No. 61/261,208, filed on Nov. 13, 2009.

(51) Int. Cl. A63B 53/00; B05D 3/06

(52) U.S. Cl. 473/316; 427/555

(57) ABSTRACT

A golf club shaft, includes a flexible, elongate, tapered, fiber-reinforced generally cylindrical body formed from a fiber/resin matrix having carbon fibers embedded therein, an interior coating layer applied substantially continuously over the surface of the cylindrical body along the length and circumference of the cylindrical body, a plurality of secondary coating layers formed over the interior coating layer including an exterior coating layer, each secondary coating layer having a different color and surrounding at least one etched area wherein one or more secondary coating layers has been removed to expose one or more coating layers between the exterior coating layer and the interior coating layer, each coating layer having a different color; and wherein the difference in the thickness of the secondary coatings in the etched area is discernable from the remainder of the surface of the cylindrical body via tactile sensation when the golf shaft is gripped by a user.

### CROSS-REFERENCE TO RELATED APPLICATIONS

This application claims the benefit of U.S. Provisional Application No. 61/261,208, filed Nov. 13, 2009, and entitled FIBER-REINFORCED PLASTIC ARTICLE HAVING SURFACE TEXTURE.

### TECHNICAL FIELD

The following disclosure relates to articles formed of a fiber-reinforced composite material having a surface texture. It further relates to methods for forming a surface texture on fiber-reinforced composite articles using laser surface etching, surface relieving and appliqué, and/or molding. In particular, the disclosure relates to golf club shafts and methods of preparing golf club shafts having selected exterior surface areas that are visually and tactilely distinguishable from the remainder of the shaft.

### BACKGROUND

Fiber-reinforced composite materials are typically made of a fiber/resin matrix wherein the fibers reinforce the matrix. Fibers commonly used in fiber-reinforced composite materials include fiberglass, carbon fiber, Kevlar, Zylon, other aramids and similar materials. Resins commonly used in fiber-reinforced composite materials include thermosetting materials such as epoxy, vinyl ester and polyester, and also thermoplastic plastics such as nylon or polypropylene. Fiber-reinforced composite materials are used in a variety of sporting goods, such as golf club shafts, fishing rods, tennis rackets, hockey sticks and similar items where the high tensile strength of the materials may be advantageously employed.

### SUMMARY

In one aspect thereof, an article including fiber-reinforced composite material wherein reinforcing fibers are embedded in a resin comprises a first portion of the fiber-reinforced composite material disposed on an exterior surface of the article and defining a substantially uniform first surface level and at least one second portion of the fiber-reinforced composite material disposed on an exterior surface of the article surrounded by the first portion. The second portion defines a second surface having a visibly different level from the first surface level, as viewed by a person with normal unaided vision. The second portion also has a surface level that differs from the surrounding exterior surface sufficient to provide a tactile sensation of texture when grasped.

In one variation, a method of producing a golf club shaft includes the steps of forming a flexible, elongate, tapered, fiber-reinforced generally cylindrical body from a resin with embedded fibers. The fibers may be carbon fibers or an equivalent thereof having high tensile strength. A first coating layer may be applied over substantially the entire surface of the cylindrical body and cured. A second coating layer having a visually distinguishable different color or appearance than the first coating layer is applied over the first layer and cured. A laser is used to etch through the second coating layer to expose the first coating layer so that the selected areas are surrounded by and visually distinguishable from the non-etched areas. The depth of the laser etched areas, relative to the remainder of the surface area of the shaft, are sufficiently deep to provide surface areas having a tactilely distinguishable sensation from the non-etched areas of the cylindrical body when gripped.

In various embodiments, a plurality of coating layers may be applied over the first coating layer, each having a visually distinct color. For example, a first layer may be black, a second layer may be white, a third layer may be yellow, a fourth layer red and so on. The coating layers are typically a paint applied by dipping, brushing, spraying or similar method and have a dry thickness in the range of from about 0.0006 to about 0.0011 inches. Thus, by controlling the depth of the etching, different colors may be exposed in the etched areas in patterns that may be geometric figures, letters, numbers and other symbols. In other embodiments, a metallic layer may be applied by known physical and/or chemical deposition techniques such as vacuum sputtering.

In one embodiment, the shaft is formed to have a taper in the range of about 0.3 inches at a first end adapted to receive a club head to about 0.7 inches at a second end adapted to receive a shaft grip. In different variations, the length of the shaft may be in the range of between about 35 inches to about 50 inches.

In another embodiment, a golf club shaft is formed from a flexible, elongate, tapered, fiber-reinforced generally cylindrical body. The generally cylindrical body includes a matrix formed from a resin with carbon fibers embedded therein. An interior coating layer is applied substantially continuously over the surface of the cylindrical body along the length and circumference of the cylindrical body. The interior coating layer may be applied directly over the resin/fiber matrix with a plurality of secondary coating layers formed over the interior coating layer. The coatings may be different colored paints wherein the dry thickness of each coating layer is in the range of from about 0.0006 to about 0.0011 inches.

The secondary coating layers include an exterior coating with each secondary coating layer having a different color and surrounding at least one etched area. One or more secondary coating layers are etched away in the etched area or areas to expose one or more coating layers between the exterior coating layer and the interior coating layer. In different variations, each coating layer has a different color or appearance and the difference in the thickness of the secondary coatings in the etched area or areas is discernable from the remainder of the surface of the cylindrical body via tactile sensation when the golf shaft is gripped by a user. The etched area or areas may be a geometric figure such as a circle, oval or polygon or may be one or more of a letter, number or similar indicia.

In one variation, the shaft comprises a first end adapted to receive a golf club head and a second end adapted to receive a grip and wherein the shaft has a taper in the range of about 0.3 inches at the first end to about 0.7 inches at the second end. The shaft may have a length in the range of between about 35 inches to about 50 inches.

### BRIEF DESCRIPTION OF THE DRAWINGS

For a more complete understanding, reference is now made to the following description taken in conjunction with the accompanying Drawings in which:

FIG. 1 is a perspective view of a portion of a fiber-reinforced composite article (in this example, a golf club shaft) having a surface texture in the form of a plurality of hexagonal shapes;

FIG. 2 is a cross-sectional side view of a portion of the article of FIG. 1;

FIGS. 3-4 are cross-sectional side views of portions of other examples of fiber-reinforced composite articles having surface textures;

FIGS. 5-7 are perspective views of other examples of fiber-reinforced composite articles having surface textures;

FIG. 8 is a top view of a portion of the surface of an example fiber-reinforced composite article having a surface texture including a plurality of substantially identical shapes in the form of triangles;

FIGS. 9-14 are enlarged top views of additional examples of fiber-reinforced composite articles having different shapes, sizes and patterns of surface textures;

FIG. 15 is a perspective view of a portion of a fiber-reinforced composite article having surface texture in the form of a plurality of straight channels;

FIG. 16 is a perspective view of a portion of a fiber-reinforced composite article having surface texture in the form of a plurality of serpentine channels;

FIG. 17 is a perspective view of a portion of a fiber-reinforced composite article having surface texture in the form of a straight rib;

FIG. 18 is a perspective view of a portion of a fiber-reinforced composite article having surface texture in the form of a helical rib;

FIG. 19 is a partial perspective view of a cylindrical fiber-reinforced composite article and apparatus for laser etching the surface of the article;

FIG. 20 is an enlarged view of an etched portion of the cylindrical article of FIG. 19;

FIG. 21 is a partial cross-sectional view of the cylindrical article of FIG. 19 taken through an etched area of the article;

FIG. 22 is a partial perspective view of a golf club including a golf club shaft having etched surface coatings according to the disclosure;

FIG. 23 is an enlarged view of an etched area of the golf club shaft of FIG. 22; and

FIG. 24 is a cross-sectional view of the golf club shaft of FIG. 23 taken through a non-etched area of the shaft.

### DETAILED DESCRIPTION

Referring now to the drawings, wherein like reference numbers are used herein to designate like elements throughout, the various views and embodiments of laser etching of surface features and cylindrical articles produced thereby are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

This disclosure is applicable to use in connection with all types of fiber-reinforced composite articles. For example, composite golf club shafts, composite fishing rods, composite ski poles, composite tent poles and composite arrow shafts may be formed according to the disclosure and any of the examples set forth below.

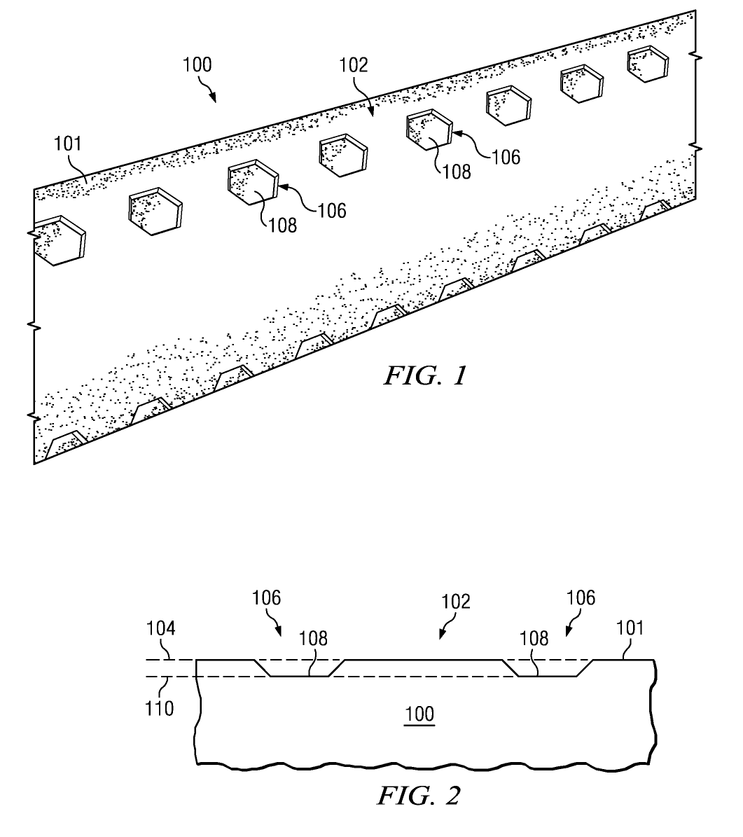

Referring to FIGS. 1 and 2, there is illustrated one example of a fiber-reinforced composite article having surface texture. Article 100 is formed of a fiber-reinforced composite material having a fiber/resin matrix within which are embedded reinforcing fibers. The resin material may be, but is not limited to, a thermosetting plastic such as epoxy, vinyl ester and polyester, or a thermoplastic plastic such as nylon or polypropylene. The reinforcing fibers embedded within the fiber/resin matrix may be, but are not limited to, fiberglass, carbon fiber, Kevlar, Zylon, other aramid fibers and similar materials.

A first portion 102 of the composite material in the article 100 is disposed on an exterior surface 101 of the article and defines a substantially uniform first surface level 104 (FIG. 2). At least one second portion 106 of the composite material is disposed on the exterior surface of the article 100 surrounded by the first portion 102. In the example shown in FIGS. 1 and 2, a plurality of second portions 106 are disposed on the article 100. Each second portion 106 defines a second surface 108 having a visibly different level 110 (FIG. 2) from the first surface level 104. The difference between the level 104 of the first portion 102 and the level 110 of the second portion 108 may be visible by a person with normal unaided vision. In this example, the level 110 of the second portions 106 is below the first surface level 104 of the first portion 102.

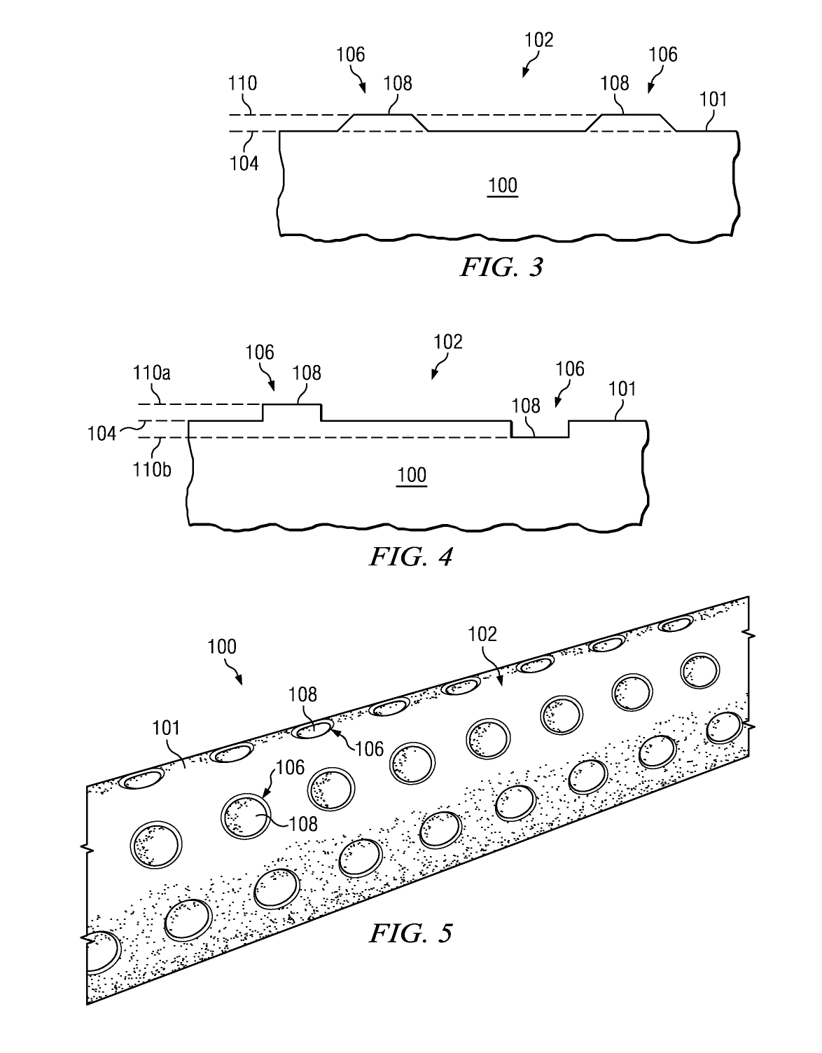

Referring now to FIG. 3, in another example, the level 110 of the second portions 106 is above the first surface level 104 of the first portion 102.

Referring now to FIG. 4, in another example, the level 110a of some second portions 106 is above the first surface level 104 of the first portion 102, while the level 110b of other second portions is below the level of the first portion.

Referring again to FIG. 1, the article 100 in this example, includes a first plurality of second portions 106 that are distributed throughout the first portion 102, and each of the first plurality of second portions has substantially the same shape, when viewed from above. In this example, the second portions in the first plurality have a hexagonal shape, when viewed from above. In other examples (not shown), the second portions 106 may be at a level above, below or both above and below the level of the first portion 102.

Referring now to FIG. 5, in another example, the article 100 includes a first plurality of second portions 106 that are distributed throughout the first portion 102, and each of the first plurality of second portions has a round or circular shape, when viewed from above. In this example, the second portions 106 are below the level of the first portion 102; however, in other examples (not shown), the second portions 106 may be at a level above, below or both above and below the level of the first portion 102.

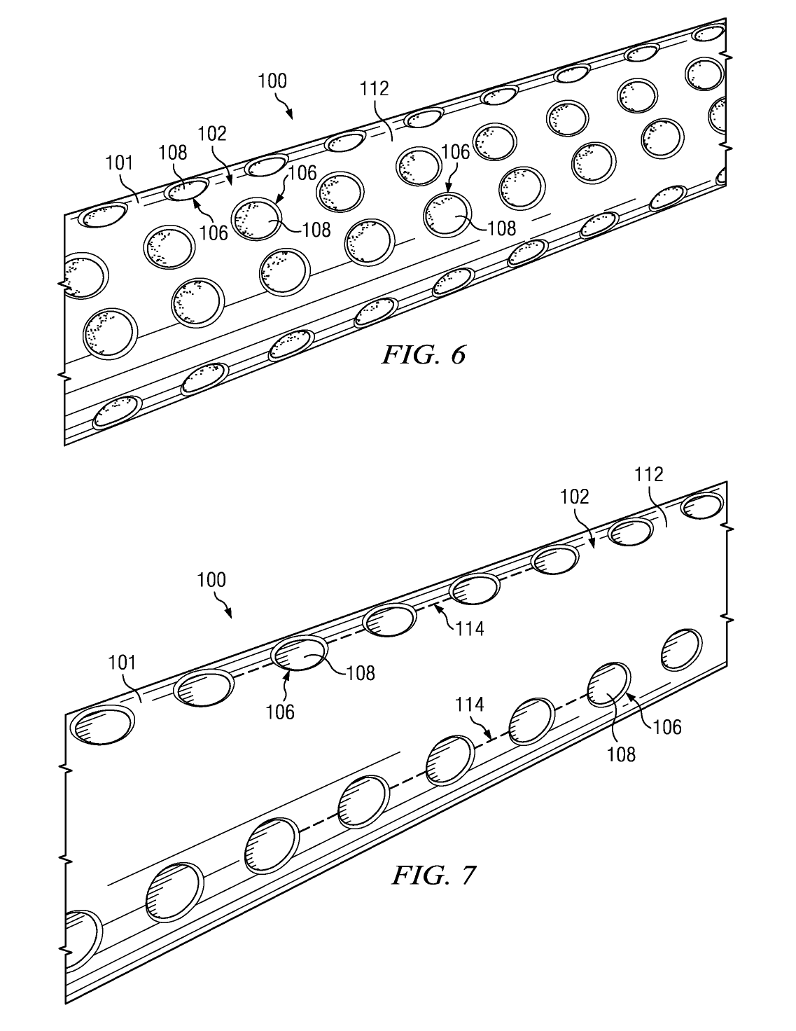

Referring now to FIG. 6, in another example the article 100 includes a first plurality of second portions 106 that are distributed throughout the first portion 102, and each of the first plurality of second portions has a round or circular shape, when viewed from above. In this example, the article 100 further comprises a layer of paint, resin or other coating material 112 applied over the composite material exterior surface. In the example shown, the coating material 112 completely covers the first portion 102, but only partially covers the second portions 106. In other examples (not shown), the second portions 106 may be at a level above, below or both above and below the level of the first portion 102.

Referring now to FIG. 7, in another example, the article 100 includes a coating material 112 that completely covers the first portion 102 and the second portions 106. Due to the difference in levels between the first portion 102 and the second portions 106; however, the surface texture is still visible to a person with normal, unaided vision. In this example, some of the second portions 106 are grouped together and disposed in lines 114 extending lengthwise along the article 100.

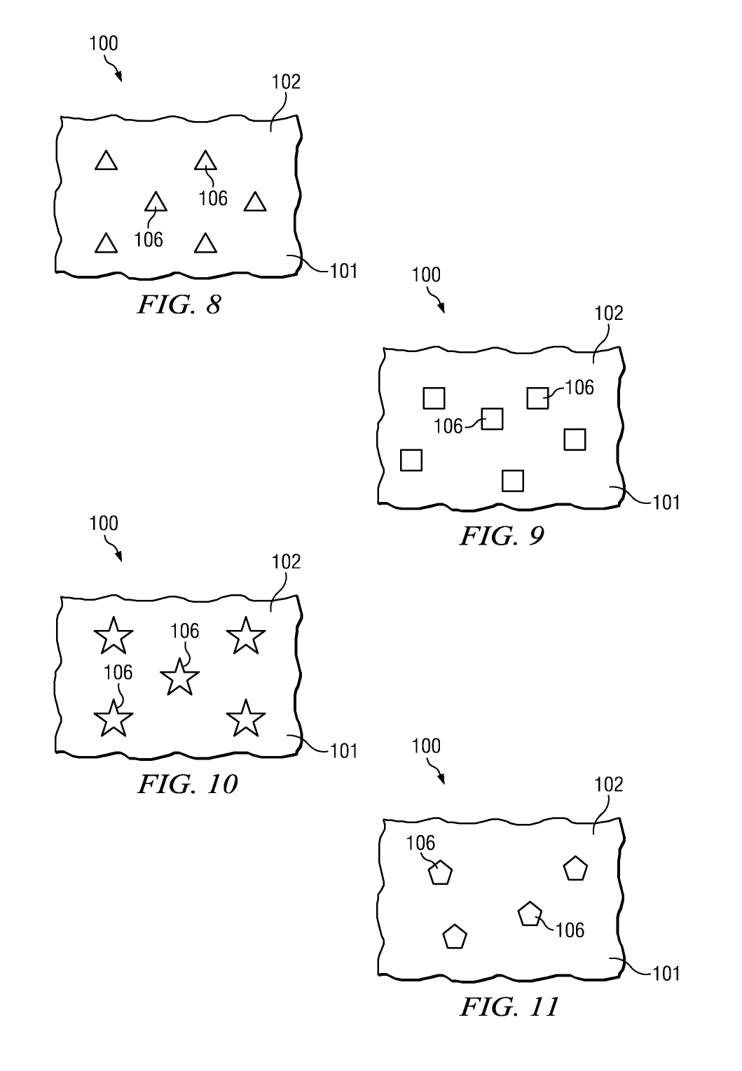

Referring now to FIG. 8, in another example, the article 100 includes a first plurality of second portions 106 that are distributed throughout the first portion 102, and each of the first plurality of second portions have a triangular shape, when viewed from above. The second portions 106 may be at a level above, below or both above and below the level of the first portion 102.

Referring now to FIG. 9, in another example, the article 100 includes a first plurality of second portions 106 that are distributed throughout the first portion 102, and each of the first plurality of second portions has a square shape, when viewed from above. The second portions 106 may be at a level above, below or both above and below the level of the first portion 102.

Referring now to FIG. 10, in another example, the article 100 includes a first plurality of second portions 106 that are distributed throughout the first portion 102, and each of the first plurality of second portions has a star shape, when viewed from above. The second portions 106 may be at a level above, below or both above and below the level of the first portion 102.

Referring now to FIG. 11, in another example, the article 100 includes a first plurality of second portions 106 that are distributed throughout the first portion 102, and each of the first plurality of second portions has a pentagonal shape, when viewed from above. The second portions 106 may be at a level above, below or both above and below the level of the first portion 102.

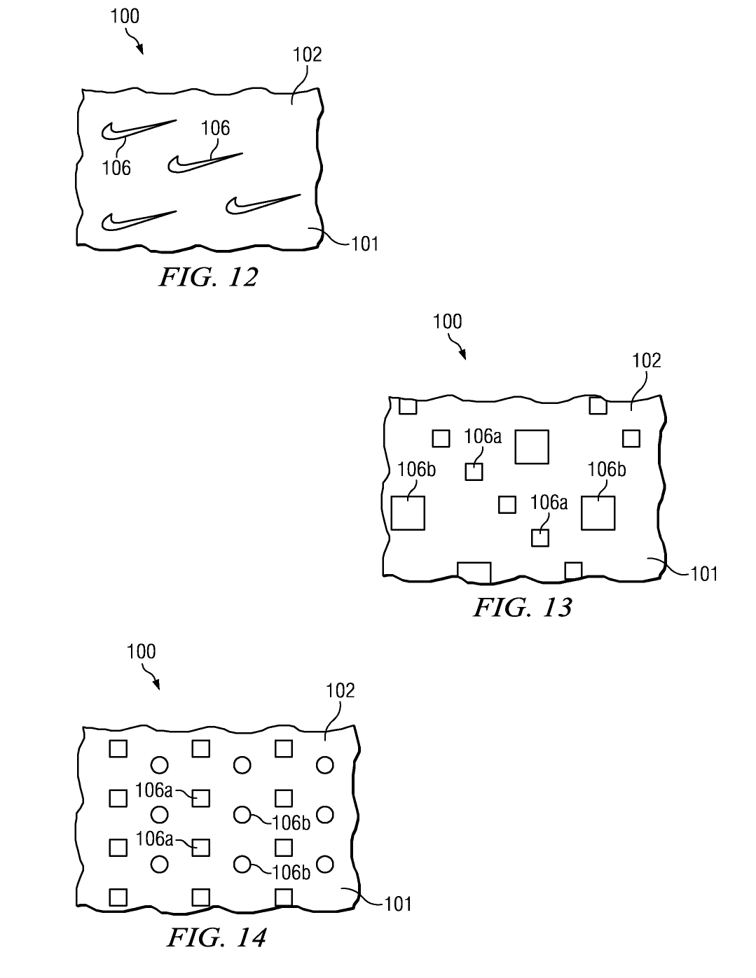

Referring now to FIG. 12, in another example, the article 100 includes a first plurality of second portions 106 that are distributed throughout the first portion 102, and each of the first plurality of second portions has a swoosh shape, when viewed from above. The second portions 106 may be at a level above, below or both above and below the level of the first portion 102.

Referring now to FIG. 13, in another example, the article 100 includes a first plurality of second portions (denoted 106a) that are distributed throughout the first portion 102, and each of the first plurality of second portions 106a has the same shape, when viewed from above. The article 100 of this example further includes a second plurality of second portions (denoted 106b) that are distributed throughout the first portion 102, and each of the second plurality of second portions 106b has substantially the same shape, when viewed from above. The second portions 106a and 106b may be at a level above, below or both above and below the level of the first portion 102. In the example shown in FIG. 13, the second portions 106a of the first plurality and the second portions 106b of the second plurality have substantially the same shape, when viewed from above. In this example, the second portions 106a and 106b have substantially square shapes of different sizes. In other examples (not shown), the second portions 106a and 106b may have other shapes of different sizes.

Referring now to FIG. 14, in another example, the article 100 includes a first plurality of second portions 106a that are distributed throughout the first portion 102, and each of the first plurality of second portions 106a has the same shape, when viewed from above. The article 100 of this example further includes a second plurality of second portions 106b that are distributed throughout the first portion 102, and each of the second plurality of second portions 106b has substantially the same shape, when viewed from above. The second portions 106a and 106b may be at a level above, below or both above and below the level of the first portion 102. In the example shown in FIG. 14, the second portions 106a of the first plurality and the second portions 106b of the second plurality have different shapes, when viewed from above. In this example, the second portions 106a have a square shape, and the second portions 106b have a round or circular shape. In other examples (not shown), the second portions 106a and 106b may have other combinations of different shapes.

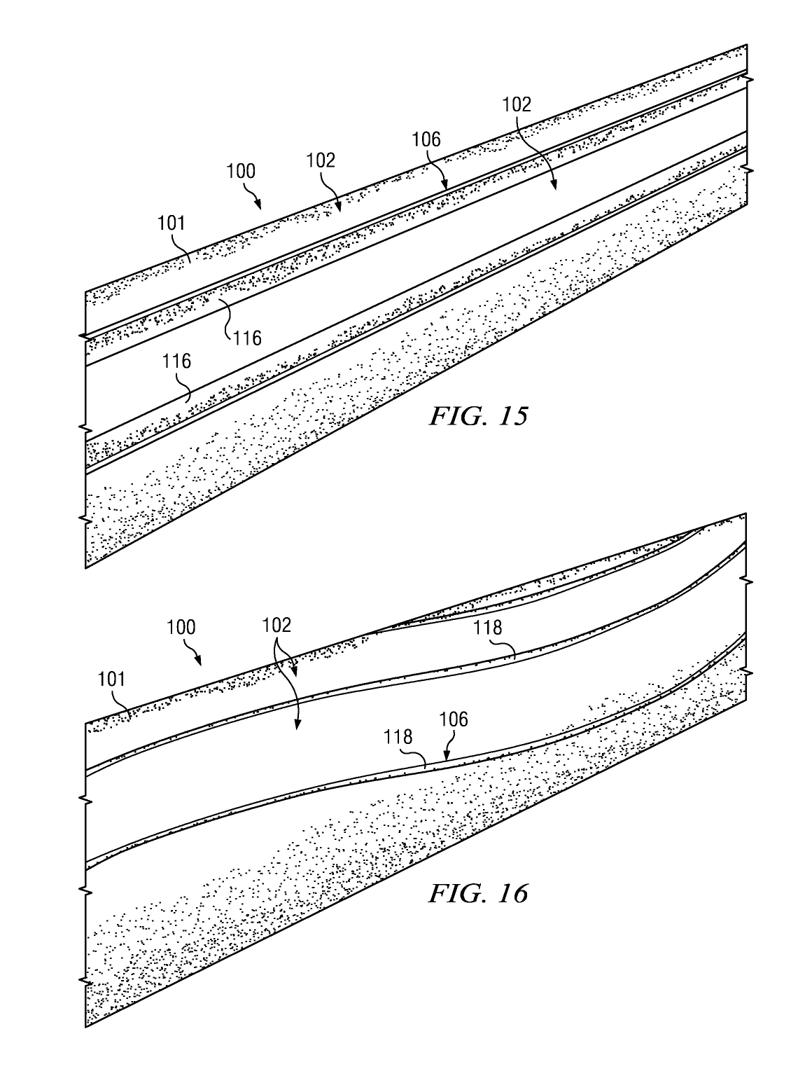

Referring now to FIG. 15, in another example, a first portion 102 of the composite material in the article 100 is disposed on an exterior surface 101 of the article and defines a substantially uniform first surface level 104 (see, e.g., FIG. 2). At least one second portion 106 of the composite material is disposed on the exterior surface of the article 100 surrounded by the first portion 102 so as to define a channel 116 running substantially lengthwise along the article. The difference between the level 104 of the first portion 102 and the level of the channel 116 (i.e., at the base) may be visible by a person with normal unaided vision. In the example shown in FIG. 15, the article includes multiple parallel channels 116 that are substantially straight.

Referring now to FIG. 16, in another example, a first portion 102 of the fiber-reinforced composite material in the article 100 is disposed on an exterior surface 101 of the article and defines a substantially uniform first surface level, and at least one second portion 106 of the fiber-reinforced composite material is disposed on the exterior surface of the article 100 surrounded by the first portion 102 so as to define a serpentine channel 118 running substantially lengthwise along the article. The difference between the level of the first portion 102 and the level of the serpentine channel 118 may be visible by a person with normal unaided vision. In the example shown in FIG. 16, the article includes multiple parallel serpentine channels 118.

In another example (not shown), a first portion of the fiber-reinforced composite material in the article is disposed on an exterior surface of the article and defines a substantially uniform first surface level, and at least one second portion of the fiber-reinforced composite material is disposed on the exterior surface of the article surrounded by the first portion so as to define a helical channel running around the article.

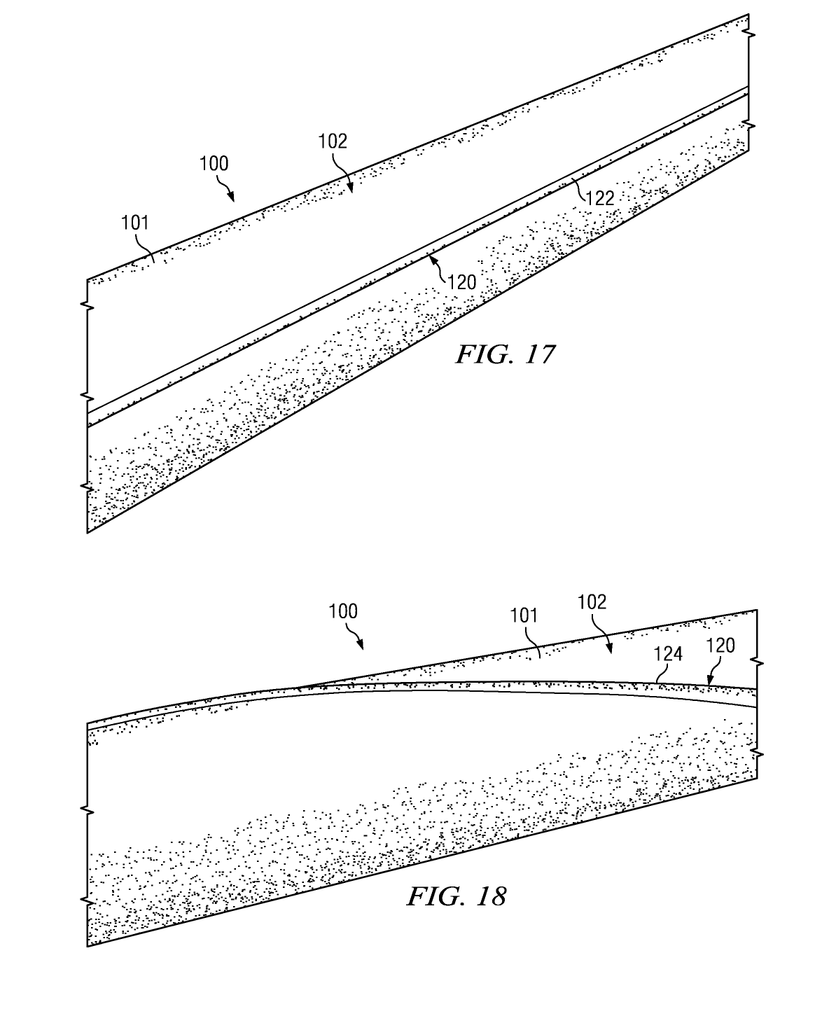

Referring now to FIG. 17, in another example, a first portion 102 of the fiber-reinforced composite material in the article 100 is disposed on an exterior surface 101 of the article and defines a substantially uniform first surface level 104 (see, e.g., FIG. 2). At least one appliqué member 120 formed of fiber-reinforced composite or another compatible material is affixed to the exterior surface of the article 100 surrounded by the first portion 102 so as to define a rib 122 running substantially lengthwise along the article. The difference between the level 104 of the first portion 102 and the level of the rib 122 (i.e., at the top) may be visible by a person with normal unaided vision. In the example shown in FIG. 17, the article 100 includes a single rib 122 that is substantially straight. In other examples (not shown), multiple ribs 122 may be provided. The rib 122 may be attached to the first portion 102 before, during or after formation of the first portion 102.

Referring now to FIG. 18, in another example, a fiber-reinforced composite article 100 may include an appliqué member 120 that is a helical rib 124 attached to the first portion 102. In other examples (not shown), multiple helical ribs 124 may be attached to the first portion 102. In still other examples (not shown), serpentine-shaped ribs may be attached to the first portion 102. The rib 124 may be made of fiber-reinforced composite material or another compatible material, and may be attached to the first portion 102 before, during or after formation of the first portion 102.

Fiber-reinforced composite articles having a surface texture in accordance with this disclosure may provide different functional characteristics than similar fiber-reinforced composite articles that do not have the surface texture. For example, in elongated fiber-reinforced composite articles such as golf club shafts or fishing rods, the flexural stiffness characteristics, the torsional stiffness, and/or the noise production characteristics (e.g., the intensity or frequency of noise produced when swinging the article through the air) may be adjusted by forming surface textures in accordance with the disclosure. Surface textures formed on an elongate fiber-reinforced shaft such as a golf club shaft may also provide the shaft with greater stability. Although the exact mechanism is unknown, it is believed that forming a fiber-reinforced shaft with a textured surface, such as a golf club shaft, may improve the stability of the shaft as the shaft is swung.

In some examples, differences in torsional or flexural strength characteristics may result from the selective strengthening or weakening of the article at the location of each texture feature. In such examples, the localized strengthening or weakening of the article at each texture feature may cumulatively affect the stiffness of the entire article along various flexure or torsion axes. By varying the size, pattern, shape, depth, distribution and/or other characteristics of the texture features, the mechanical strength and other characteristics of the article may be selectively adjusted.

In other examples, the size, pattern, shape, depth, distribution and/or other characteristics of the texture features may be adjusted to selectively affect the noise production characteristics of the article. In some examples, the texture features may modify the airflow over the article when it is swung through the air (e.g., for a golf club shaft or fishing rod). For example, the type of airflow (e.g., laminar or turbulent) and/or the position of the various airflows (e.g., near the grip, near the tip, etc.) can be selected to change the noise production characteristics of the article.

An article 100 including a fiber-reinforced composite material having a matrix formed from a resin within which reinforcing fibers are embedded. Article 100 may be produced by forming a first portion 102 of the fiber-reinforced composite material disposed on an exterior surface 101 of the article to define a substantially uniform first surface level 104 and then forming at least one second portion 106 of the fiber-reinforced composite material disposed on the exterior surface of the article surrounded by the first portion to define a second surface 108 having a visibly different level from the first surface level, as viewed by a person with normal unaided vision.

In one example, at least one second portion 106 is formed on the article 100 by etching away fiber-reinforced composite material from the first surface level 104 (FIG. 3)within the second portion area, whereby the level 110 of the resulting second portion is below the first surface level. In another example, the etching of the fiber-reinforced composite to form the second portion 106 is performed using a laser. In some examples, the laser may be a continuous wave laser, and in other examples, it may be a pulse laser. In some examples, a programmable laser may be used to form second portions 106 having complex patterns or shapes. In yet another example, the laser is operated to selectively remove the fiber/resin matrix material and leave the reinforcing fibers. In still another example, the laser is operated to melt the fiber/resin matrix material around the remaining reinforcing fibers.

In another example, at least one second portion 106 is formed on the article 100 by relieving away fiber-reinforced composite material from the first surface level 104 in the area surrounding the second portion area 106, whereby the level of the resulting second portion is above the first surface level.

In another example, at least one second portion 106 is formed on the article 100 by molding the fiber-reinforced composite material before it is fully cured. In one such example, the second portion 106 is formed by pressing the uncured or partially-cured exterior surface 101 against a patterned exterior die from the underside (e.g., using an inflatable mandrel). In another such example, the second portion 106 is formed by placing a textured article against the uncured or partially cured exterior surface 101, wrapping the exterior with shrink wrap or another compressive material, and then compressing the textured article against the fiber-reinforced composite material while it is supported from the underside by a rigid mandrel.

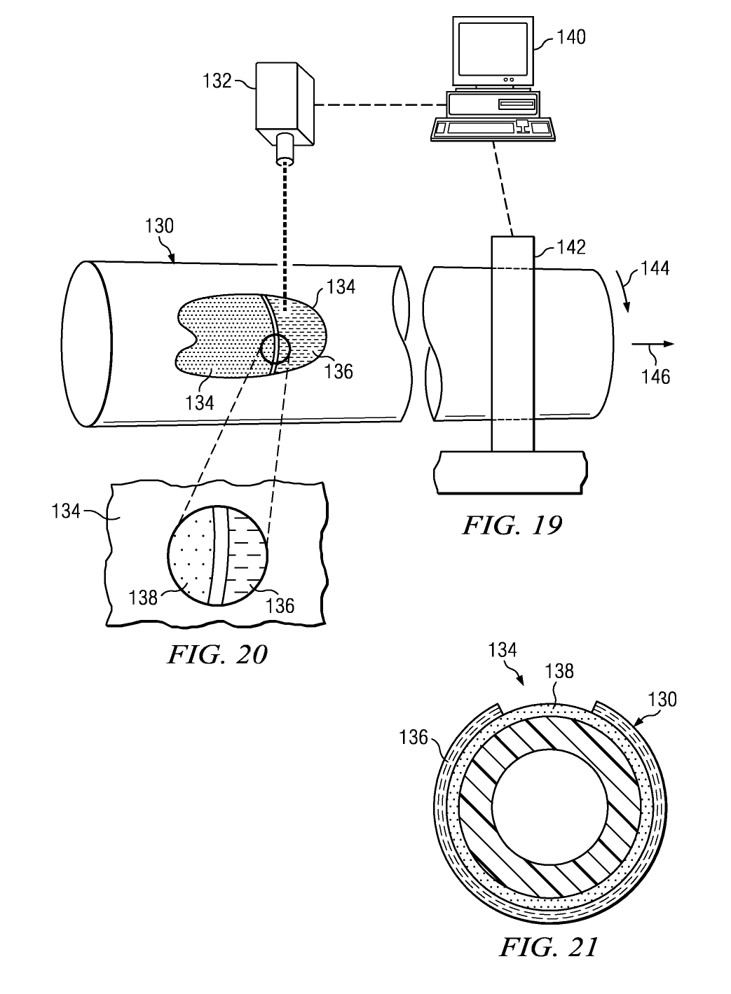

FIG. 19 illustrates a cylindrical, tapered shaft 130 formed from a fiber-reinforced composite such as a carbon fiber composite, fiberglass or similar composite of fibers embedded in a polymer or polymer resin such as a thermosetting plastic, for example, an epoxy, vinyl ester or polyester or a thermoplastic plastic such as nylon or polypropylene. In one embodiment, shaft 130 is formed using carbon fiber “prepegs,” i.e., carbon fiber cloth formed from woven carbon fibers and impregnated or coated with a polymer resin. The prepegs are cut to the desired shapes and wrapped around a mandrel having the desired geometry and a heat shrink or compression wrap is applied over the pregegs. The prepegs may then be cured with vacuum, compression molding, and/or heat. After curing, the mandrel is removed and any surface irregularities removed from shaft 130, for example, by sanding or blasting with an abrasive material. One or more coatings 136, 138 are then applied to the shaft.

Shaft 130 may be adapted for use as a golf club shaft, a fishing rod, a ski pole, a tennis racket handle, an arrow shaft or a similar shaft typically used for recreational equipment and accessories. In one embodiment, shaft 130 is adapted for use as the shaft of a golf club. In this embodiment, shaft 130 is typically tapered from a smaller diameter first end, whereon a club head may be installed to a larger diameter second end where a golf club grip is installed. The shaft 130 will typically have a taper (prior to trimming for head and grip installation), from about 0.3 inches to about 0.7 inches over a length of from about 35 inches to about 50 inches. Prior to installation of the club head and grip, shaft 130 is typically trimmed to the desired length depending upon the club head to be installed on the shaft, the reach or height of the user and other factors including the personal preferences of the user.

In the case of golf club shafts, composite graphite shafts generally have the advantage of being lighter than traditional steel shafts. The decreased weight of a composite graphite shaft as compared to a traditional steel shaft, may, for some players, translate into a faster swing with an accompanying increase in the distance that a golf ball is driven. Composite graphite shafts are also reported to transmit less vibration to the golfer's hands at the time the club head strikes the golf ball. For some players, this is a desirable feature. Further, by varying the weave, geometry and thickness of the fibers in the prepegs used to form the shafts, the stiffness of the shafts may be varied to accommodate the preferences and skill level of different players. The flexibility of a golf club shaft may also be varied by varying the taper of the shaft. As previously noted, it is believed that in some in some instances, providing the shaft with a textured finish by means of etching as described herein, may increase the stability of the shaft during the golf swing.

Referring again to FIG. 19, coatings 136, 138 are typically paints or resins having a dry thickness in the range of from about 0.0006 to about 0.0011 inches. Coatings 136, 138 may be the same or different colors and may include a transparent “clear coat.” Coatings 136, 138 may extend over the entire length of shaft 130, or over selected areas of the shaft, depending upon the desired visual effect and/or tactile sensation when the shaft is gripped by a user. Although as illustrated, two coating layers 136, 138 are applied to shaft 130, a single coating layer may be used, or alternatively, a greater number of coating layers, e.g., 3, 4, 5, 6 or more coating layers may be applied depending upon the desired visual and tactile effects. Coatings 136, 138 may be applied by successively dipping the shaft into different coating materials with the coatings being allowed to cure, with or without heating, between the successive applications of the coating materials. In one embodiment, one or both of coatings 136, 138 may be a urethane, acrylic, an epoxy or a modified epoxy acrylic urethane.

Alternatively, coatings 136, 138 may be applied by spraying, brushing, or wiping the coating materials onto the shaft, again allowing the coatings to cure between applications. Coatings 136, 138 may be applied as a powder coating or in the form of a film or decal. In different variations, coatings 136, 138 may be applied by screen printing. In yet other embodiments, one or both of coatings 136, 138 may be a metallic layer applied by ion plating, a physical vapor deposition process wherein a thin metallic layer, e.g., aluminum, gold, copper, etc, is applied to a substrate by known techniques. For example, a chrome-like metallic appearance may be obtained by applying a thin layer of aluminum to shaft 130.

As illustrated, in one embodiment, a laser 132 is used to etch a patterned area 134 on the surface of cylindrical tapered shaft 130. FIG. 20 is an enlarged view of patterned area 134 and FIG. 21 is a cross-sectional view of shaft 130 taken through etched and patterned area 134. Patterned area 134 may be etched through one or both coatings 136, 138 depending upon the desired visual effect. When different colors are used for coatings 136, 138, a visual pattern of the contrasting colors is created. For example, if inside coating 138 is a yellow paint and outside coating 136 is black, a yellow on black visual effect can be achieved by etching through the outside coating layer to expose the inside coating layer. In this example, the generally oval etched area 134 would appear yellow and the surrounding surface area would appear black. Similarly, three coatings (not shown) comprising black, yellow and red paints could be applied to shaft 130, in which case, selective etching of the surface of the shaft could result in patterns having a black-yellow-red appearance in different areas. Although the etched pattern in FIG. 19 is generally oval, different patterns such as squares, circles, triangles, hexagons or a combination thereof may be etched into the exterior surface of shaft 130. In different variations, the etched pattern may be letter(s), number(s) or similar symbols. As will be appreciated, multiple layers of different colored coatings may be applied to shaft 130 and etched to various depths to achieve the desired visual effects.

Referring to FIG. 19, laser 132 may be a continuous wave laser or a pulsed laser. In one embodiment, laser 132 is a computer controlled 60 Watt CO2 laser. The intensity and duration of the laser beam in a given position is controlled by computer 140, which includes a programmable processor to control the intensity of the laser as shaft 130 is moved past the laser. In order to move shaft 130 during the etching operation, the shaft may be mounted in a powered rotary jig 142, also controlled by computer 140 that rotates the shaft as indicated by arrow 144 during the etching process. Jig 142 may also be mounted for translation along the length of the shaft as indicated by arrow 146. Thus, the depth of the etch of patterned area 134 may be controlled by varying the beam intensity or power output of laser 132. The depth of the etch may also be controlled by the rate of rotation and linear movement of shaft 130, which determines the duration of time that the beam strikes shaft 130 in a selected area. Preferably, laser 132 has sufficient power and is controlled such that the laser can selectively etch through one or multiple layers of coatings in a single pass past the laser.

Many users of sporting goods and accessories such as golf clubs and fishing rods, prefer a shaft having a textured surface that when grasped provides a tactile sensation other than a smooth surface. A textured surface may provide a better grip on the shaft if there is moisture or another slippery material on the shaft. A textured surface may also enable the user to identify the shaft and or device to which the shaft is connected without looking directly at the shaft or device. For example, a golfer removing a club from a golf bag may identify the club as his based upon the tactile sensation provided when he or she grasps the club, preventing the golfer from removing the wrong club from the bag or removing a club from another player's bag. A textured surface may also provide a pleasing appearance.

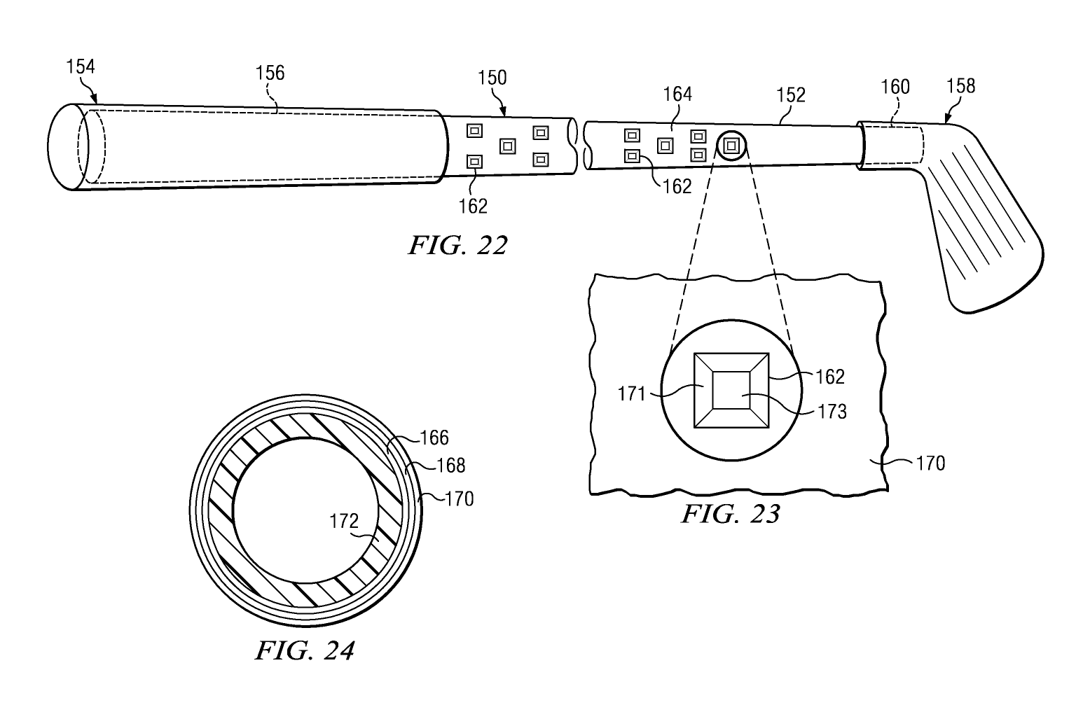

FIG. 22 is a partial perspective view of a golf club 150 employing a shaft 152 including a laser etched surface as disclosed herein. A grip 154 is mounted on the butt end 156 of shaft 152 and a club head 158 is mounted on the tip end 160 of the shaft. As illustrated, a plurality of patterned, etched surfaces or areas 162 having different depths are formed on the exterior surface 164 of shaft 152 between grip 154 and club head 158.

FIG. 23 is an enlarged view of one of the etched surfaces or areas 162 formed on shaft 152. FIG. 24 is a cross-sectional view of shaft 152 taken through the shaft in a non-etched area. Referring to FIGS. 23 and 24, in this embodiment, three coating layers 166, 168 and 170 have been applied over the cylindrical carbon fiber matrix 172 of shaft 152. Each of coating layers 166, 168, 170, are formed from a different colored paint or coating. For example, exterior layer 170 may be blue, intermediate layer 168 may be white and interior layer 166 may be yellow. In different variations, interior coating layer 166 is applied substantially continuously over the entire surface of shaft 152 with one or more secondary layers, for example layers 168, 170 applied over the interior coating layer. Secondary coating layers 168, 170 may be applied substantially continuously over the length and circumference of shaft 152, or over selected regions of the exterior surface of the shaft.

Referring to FIG. 23, exterior layer 170 and intermediate layer 168 include etched areas 162 where one or more of the coating layers have been etched to expose one or more coating layers between the exterior coating layer 170 and shaft 152. In this example, the exterior surface of shaft 152 will appear blue, surrounding etched surfaces 162, each of which includes a white, generally square area 171 where the blue paint has been etched away. Area 171 surrounds a smaller, generally square area 173 where the blue coating layer 170 and the intermediate white coating layer 168 have been etched away, exposing the yellow interior coating layer 166.

The depths of etched coating layers 168 and 170 is sufficient to provide a user of the golf club with a tactile sensation of a texture when the user grasps shaft 152 in region or regions of the shaft where patterned areas 162 have been laser etched. Although, as illustrated, the etched patterned areas 162 are square, the patterned areas could also be in the form of letters, numbers and other symbols. For example, a manufacturer could etch one or more of a multi-colored name, model number, trademark or other symbol into the exterior surface of shaft 152.

It will be appreciated by those skilled in the art having the benefit of this disclosure that the disclosure provides a method of laser etching of surface features and cylindrical articles produced thereby, in particular, golf club shaft shafts. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A cylindrical shaft comprising:
a flexible, elongate, tapered, fiber-reinforced generally cylindrical body formed from a fiber/resin matrix having fibers embedded therein;
at least one coating applied substantially continuously over the exterior surface of the body along the circumference and length of the body, wherein the coating on the exterior surface of the cylindrical body has first and second regions, the second regions surrounding the first regions; and
wherein the exterior surface of the first region has a first surface level and the exterior surface of the second region has a second surface level whereby the difference of the thickness of the first and second regions is visible to the normal, unaided eye and wherein the difference in the thickness of the first and second regions is discernable via tactile sensation when the cylindrical body is gripped with a human hand.

2. The cylindrical shaft of claim 1, wherein the shaft comprises a golf club shaft having first and second ends adapted to receive a golf club head and a grip and wherein the fibers embedded in the fiber/resin matrix comprise carbon fibers.

3. The cylindrical shaft of claim 2, wherein the shaft has a length of between about 35 inches to about 50 inches.

4. The cylindrical shaft of claim 3, wherein the shaft has first and second ends and the shaft has a taper in the range of about 0.3 inches at the first end to about 0.70 inches at the second end.

5. The cylindrical shaft of claim 1, wherein the dry thickness of the coating layer is in the range of from about 0.0006 to about 0.0011 inches.

6. The cylindrical shaft of claim 1, further comprising a plurality of coatings applied in successive layers over fiber-reinforced generally cylindrical body and wherein each of the coatings comprises a paint having a different color than an adjacent coating.

7. A golf club shaft, comprising:
a flexible, elongate, tapered, fiber-reinforced generally cylindrical body formed from a fiber/resin matrix having carbon fibers embedded therein;
an interior coating layer applied substantially continuously over the surface of the cylindrical body along the length and circumference of the cylindrical body,
a plurality of secondary coating layers formed over the interior coating layer including an exterior coating, each secondary coating layer having a different color and surrounding at least one etched area wherein one or more secondary coating layers has been removed to expose one or more coating layers between the exterior coating layer and the interior coating layer, each coating layer having a different color; and
wherein the difference in the thickness of the secondary coatings in the etched area is discernable from the remainder of the surface of the cylindrical body via tactile sensation when the golf shaft is gripped by a user.

8. The golf club shaft of claim 7, wherein the shaft comprises a first end adapted to receive a golf club head and a second end adapted to receive a grip and wherein the shaft has a taper in the range of about 0.3 inches at the first end to about 0.70 inches at the second end.

9. The golf club shaft of claim 7, wherein the shaft has a length of between about 35 inches to about 50 inches.

10. The golf club shaft of claim 7, wherein the dry thickness of each coating layer is in the range of from about 0.0006 to about 0.0011 inches.

11. The golf club shaft of claim 7, wherein the at least one etched area comprises one or more of a letter or number.

12. The golf club shaft of claim 7, further comprising a plurality of etched areas.

13. The golf club shaft of claim 12, wherein the plurality of etched areas includes one or more of a letter or number.

14. A method of producing a golf club shaft, comprising:
forming a flexible, elongate, tapered, fiber-reinforced generally cylindrical body from a fiber/resin matrix having fibers embedded therein;
applying a first coating layer over substantially all of the surface of the cylindrical body;
curing the first coating layer over the exterior surface of the cylindrical body;
applying a second coating layer over the first coating layer, the second coating layer having a visually distinguishable different color than the first coating layer;
etching through the second coating layer in selected areas with a laser to expose the first coating layer such that the selected areas are surrounded by and visually distinguishable from the non-etched areas; and
wherein the surface of the selected laser-etched areas is tactilely distinguishable from the non-etched areas of the cylindrical body when gripped.

15. The method of claim 14, wherein the step of forming a flexible, elongate, tapered, fiber-reinforced generally cylindrical body from a fiber/resin matrix having fibers embedded therein includes forming the body from a fiber/resin matrix including carbon fibers embedded therein.

16. The method of claim 14, wherein the first and second coating layers have a dry thickness in the range of from about 0.0006 to about 0.0011 inches.

17. The method of claim 14, wherein the step of forming a flexible, elongate, tapered, fiber-reinforced generally cylindrical body from a fiber/resin matrix having fibers embedded therein further comprises forming a shaft having a taper in the range of about 0.3 inches at a first end to about 0.7 inches at a second end and wherein the fibers are carbon fibers.

18. The method of claim 17, wherein the step of forming a flexible, elongate, tapered, fiber-reinforced generally cylindrical body from a fiber/resin matrix having carbon fibers embedded therein further comprises forming a shaft having a length in the range of from between about 35 inches to about 50 inches.

19. The method of claim 14 further comprising applying a plurality of secondary coating layers over the first coating layers, each of the secondary coating layers having a visually distinct color from each of the other coating layers.

20. The method of claim 19 further comprising laser etching the plurality of secondary coating layers in selected areas to expose portions of the secondary coating layers having visually distinguishable different colors and wherein the etched secondary layers have a depth sufficient to provide tactilely distinguishable areas on the cylindrical body when grasped.
